(19) United States
(12) Patent Application Publication
(10) Pub. No.: US 2023/0252769 A1
(43) Pub. Date: Aug. 10, 2023

(54) SELF-SUPERVISED MUTUAL LEARNING FOR BOOSTING GENERALIZATION IN COMPACT NEURAL NETWORKS

(71) Applicant: NavInfo Europe B.V., Eindhoven (NL)

(72) Inventors: Prashant Bhat, Eindhoven (NL); Elahe Arani, Eindhoven (NL); Bahram Zonooz, Eindhoven (NL)

(21) Appl. No.: 17/666,055

(22) Filed: Feb. 7, 2022

(51) Int. Cl. G06V 10/774; G06V 10/82; G06V 10/74; G06N 3/04

(52) U.S. Cl. CPC G06V 10/7747; G06V 10/82; G06V 10/761; G06N 3/0454

(57) ABSTRACT

A deep learning-based method for self-supervised online knowledge distillation to improve the representation quality of the smaller models in neural network. The method is completely self-supervised, i.e. knowledge is distilled during the pretraining stage in the absence of labels. Said method comprises the step of using a single-stage online knowledge distillation wherein at least two models collaboratively and simultaneously learn from each other.

### BACKGROUND OF THE INVENTION

### Field of the Invention

The invention relates to a deep learning-based method for online knowledge distillation in self-supervised learning of a compact neural network.

### Background Art

Self-supervised learning (SSL) [1, 2, 3] solves pretext prediction tasks that do not require annotations to learn feature representations. SSL learns meaningful representations from data without requiring manually annotated labels. To learn task-agnostic visual representations, SSL solves pretext prediction tasks such as predicting relative position [4] and/or rotation [5], solve jigsaw [6] and image in-painting [7]. Predicting known information helps in learning representations generalizable for downstream tasks such as segmentation and object detection [8]. However, recent works have shown that wider and deeper models benefit more from SSL than smaller models [9].

SSL can be broadly categorized into generative and contrastive methods [15]. Generative self-supervised models try to learn meaningful visual representations by re-constructing either a part of an input or whole of it. Contrastive learning, on the other hand, learns to compare through Noise Contrast Estimation [16]. InstDisc [17] proposed instance discrimination as a pretext task. CMC [18] employed multi-view contrastive learning framework with multiple different views of an image as positive samples and take views of other images as the negatives. MoCo [19] further developed the idea of instance discrimination by leveraging momentum contrast. SimCLR [2] relinquishes momentum contrast overall but retains the siamese structure and introduces augmentations of 10 forms with an end-to-end training framework. SimCLRv2 [14] outlined that bigger models benefit more from a task agnostic use of unlabelled data for visual representation learning. Owing to larger modelling capacity, bigger self-supervised models are far more label efficient and perform better than smaller models on downstream tasks.

Knowledge Distillation (KD) [10, 11, 12] is an effective technique for improving the performance of compact models either by using the supervision of larger pre-trained model or by using a cohort of smaller models trained collaboratively. In the original formulation, Hinton et al. [20] proposed a representation distillation by way of mimicking softened softmax output of the teacher. Better generalization can be achieved by emulating the latent feature space in addition to mimicking the output of the teacher [11, 12]. Offline KD methods pre-train the teacher model and fix it during the distillation stage. Therefore, offline KD methods require longer training process and significantly large memory and computational resources to pretrain large teacher models [13]. Online knowledge distillation offers a more attractive alternative owing to its one stage training and bidirectional knowledge distillation. These approaches treat all (typically two) participating models equally, enabling them to learn from each other. To circumvent the associated computational costs of pretraining a teacher, deep mutual learning (DML) [21] proposed online knowledge distillation using Kullback—Leibler (KL) divergence. Alongside a primary supervised cross-entropy loss, DML involves training each participating model using a distillation loss that aligns the class posterior probabilities of the current model with that of the other models in the cohort. Knowledge Distillation method via Collaborative Learning, termed KDCL [22] treats all deep neural networks (DNNs) as “students” and collaboratively trains them in a single stage (knowledge is transferred among arbitrary students during collaborative training), enabling faster computations, and appealing generalization ability.

Recent works have empirically shown that deeper and wider models benefit more from task agnostic use of unlabelled data than their smaller counterparts i.e. smaller models when trained using SSL fail to close in the gap with respect to supervised training [9, 14]. Offline KD has been traditionally used to improve the representation quality of smaller models. However, offline KD methods require longer training process and significantly large memory and computational resources to pretrain large teacher models [13]. Although KD is prevalent in supervised learning, it is not well explored in the SSL domain. Moreover, poor representation quality in smaller models when trained using SSL is not addressed well in the literature.

Discussion of the publications herein is given for more complete background and is not to be construed as an admission that such publications are prior art for patentability determination purposes.

### BRIEF SUMMARY OF THE INVENTION

It is an object of the current invention to correct the shortcomings of the prior art and to solve the problem of low representation quality in smaller models when trained using SSL, all the while avoiding aforementioned problems associated with the offline KD. This and other objects which will become apparent from the following disclosure, are provided with a deep learning-based method for unsupervised contrastive representation learning of a compact neural network, having the features of one or more of the appended claims.

According to a first aspect of the invention, the deep learning-based method for unsupervised contrastive representation learning of a neural network comprises the step of using a single-stage online knowledge distillation wherein at least two models, a first model and a second model, collaboratively and simultaneously learn from each other. Online knowledge distillation offers an attractive alternative of conventional knowledge distillation owing to its one stage training and bidirectional knowledge distillation. An online approach treats all (typically two) participating models equally, enabling them to learn from each other.

In contrast to offline knowledge distillation, the proposed method starts with multiple untrained models which simultaneously learn by solving a pretext task. Specifically, the method comprises of the following steps:

Selecting two untrained models (such as ResNet-18 and ResNet-50 [23]) for collaborative self-supervised learning;
Passing a batch of input images through an augmentation module for generating at least two randomly augmented views for each input image;
Generating projections from each model, wherein the projections correspond to said randomly augmented views.
Solving instance level discrimination task, such as contrastive self-supervised learning, for each model separately as the main learning objective.
Aligning temperature scaled similarity scores across the projections of the participating models for knowledge distillation, preferably using Kullback-Leibler divergence [29].

The additional supervision signal from the collaborative learning can assist the optimization of the smaller model.

Finally, and in order to further improve the efficacy of the knowledge distillation, the method comprises the step of adjusting a magnitude of the knowledge distillation loss with the instance-discrimination loss such as contrastive loss.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a diagram of the deep learning-based method according to an embodiment of the present invention. Whenever in the figures the same reference numerals are applied, these numerals refer to the same parts.

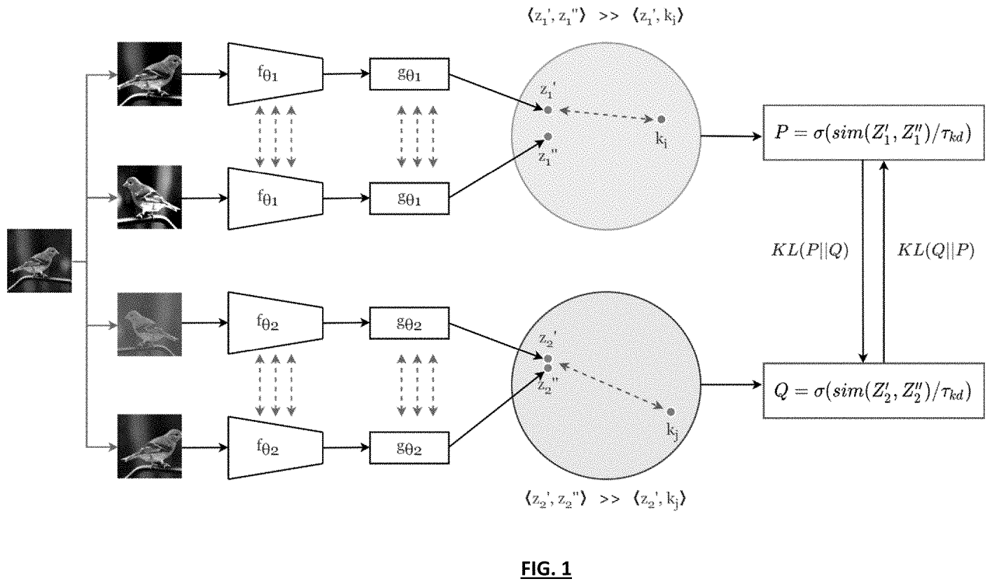

### DETAILED DESCRIPTION OF THE INVENTION

Inspired by the recent advancements in contrastive representation learning, the method according to the current invention comprises a stochastic augmentation module resulting in two highly correlated views I′ and I″ of the same input sample I. The correlated views are then fed into f_{θ}(.), typically an encoder network such as ResNet-50 [23], and subsequently to g_{θ}(.), a two-layer perceptron with ReLU non-linearity. To learn the visual representations, the network g_{θ}(f_{θ}(.)) should learn to maximize the similarity between the positive embedding pair <z′, z″> while simultaneously pushing away the negative embedding pairs <z′, kᵢ>, where i=(1, . . . , K) are the embeddings of augmented views of other samples in a batch and K is the number of negative samples. Contrastive representation learning can thus be cast as an instance level discrimination task. Instance level discrimination objective is typically formulated using a softmax criterion.

However, the cost of computing non-parametric softmax is prohibitively large especially when the number of instances is very large [24]. Popular techniques to reduce computation include hierarchical softmax [25], noise contrast estimation [16] and negative sampling [26]. Following [2, 14], We use noise contrast estimation for a positive embedding pair <zᵢ′, zᵢ″> where i∈{1, 2} indicates the two models as follows:

$${L}_{cl , i} = - log \frac{{e}^{sim ( {z}_{i}^{′} , {z}_{i}^{″} ) / {τ}_{c}}}{{e}^{sim ( {z}_{i}^{′} , {z}_{i}^{″} ) / {τ}_{c}} + {\sum }_{j = 1}^{K} {e}^{sim ( {z}_{i}^{′} , {k}_{j} ) / {τ}_{c}}} \qquad ( 1 )$$

L_{cl} is a normalized temperature scaled cross entropy loss [2]. Wang et al. [27] provided an in-depth understanding of necessity of normalization when using dot product of feature vectors in a cross-entropy loss. Therefore, we use cosine similarity (L2 normalized dot product) in the computation of the contrastive loss L_{cl}.

Smaller models find it hard to optimize and find right set of parameters in instance level discrimination tasks, attributing to difficulty of optimization rather than the model size. The additional supervision in KD regarding the relative differences in similarity between the reference sample and other sample pairs within multiple models can assist the optimization of the smaller model. Therefore, to improve generalizability of smaller model g_{θ1}(f_{θ1}(.)) we propose to utilize another peer model g_{74 2}(f_{θ2}(.)). Given a new sample, each participating peer model generates embeddings z′,z″ of two different augmented views. Let Z′, Z″∈R^{N×m} be a batch of z′, z″ where N is batch size and m is the length of the projection vector. Let P=σ(sim(Z₁′, Z₁″)/τ) and Q=σ(sim(Z₁′, Z₁″)/τ) be softmax probabilities of temperature-scaled similarity scores across augmentations of two peer models. We employ KL divergence to distill the knowledge across peers by aligning the distributions P and Q. The distillation losses are defined as follows:

$$\begin{matrix}{L}_{kd , 1} = {D}_{KL} ( Q \vert \vert P ) \\ = σ ( \frac{sim ( {Z}_{2}^{′} , {Z}_{2}^{″} )}{{τ}_{kd}} ) log \frac{σ ( sim ( {Z}_{2}^{′} , {Z}_{2}^{″} ) / {τ}_{kd} )}{σ ( sim ( {Z}_{1}^{′} , {Z}_{1}^{″} ) / {τ}_{kd} )}\end{matrix} \qquad ( 2 )$$

$$\begin{matrix}{L}_{kd , 2} = {D}_{KL} ( Q \vert \vert P ) \\ = σ ( \frac{sim ( {Z}_{1}^{′} , {Z}_{1}^{″} )}{{τ}_{kd}} ) log \frac{σ ( sim ( {Z}_{1}^{′} , {Z}_{1}^{″} ) / {τ}_{kd} )}{σ ( sim ( {Z}_{2}^{′} , {Z}_{2}^{″} ) / {τ}_{kd} )}\end{matrix} \qquad ( 3 )$$

The final learning objective for the two participating models can be written as:

L_{θ}_{₁}=L_{cl,1}+λL_{kd,1} (4)

L_{θ}_{₂}=L_{cl,2}+λL_{kd,2} (5)

where λ is a regularization parameter for adjusting the magnitude of the knowledge distillation loss. Our method can also be extended to more than two peers by simply computing distillation loss with all the peers.

Embodiments of the present invention can include every combination of features that are disclosed herein independently from each other. Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited herein are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

### REFERENCES

1. Mathilde Caron, Ishan Misra, Julien Mairal, Priya Goyal, Piotr Bojanowski, and Armand Joulin. Unsupervised learning of visual features by contrasting cluster assignments, 2021
2. Ting Chen, Simon Kornblith, Mohammad Norouzi, and Geoffrey Hinton. A simple framework for contrastive learning of visual representations, 2020
3. Xinlei Chen and Kaiming He. Exploring simple siamese representation learning, 2020
4. Carl Doersch, Abhinav Gupta, and Alexei A. Efros. Unsupervised visual representation learning by context prediction, 2015
5. Spyros Gidaris, Praveer Singh, and Nikos Komodakis. Unsupervised representation learning by predicting image rotations, 2018
6. Dahun Kim, Donghyeon Cho, Donggeun Yoo, and In So Kweon. Learning image representations by completing damaged jigsaw puzzles, 2018.
7. Deepak Pathak, Philipp Krahenbuhl, Jeff Donahue, Trevor Darrell, and Alexei A. Efros. Context encoders: Feature learning by inpainting, 2016
8. Jason D. Lee, Qi Lei, Nikunj Saunshi, and Jiacheng Zhuo. Predicting what you already know helps: Provable self-supervised learning, 2020.
9. Zhiyuan Fang, Jianfeng Wang, Lijuan Wang, Lei Zhang, Yezhou Yang, and Zicheng Liu. Seed: Self-supervised distillation for visual representation, 2021.
10. Geoffrey Hinton, Oriol Vinyals, and Jeff Dean. Distilling the knowledge in a neural network, 2015.
11. Park, Wonpyo, et al. “Relational knowledge distillation.” Proceedings of the IEEE/CVF Conference on Computer Vision and Pattern Recognition. 2019.
12. Tung, Frederick, and Greg Mori. “Similarity-preserving knowledge distillation.” Proceedings of the IEEE/CVF International Conference on Computer Vision. 2019.
13. Xu Ian, Xiatian Zhu, and Shaogang Gong. Knowledge distillation by on-the-fly native ensemble. In S. Bengio, H. Wallach, H. Larochelle, K. Grauman, N. Cesa-Bianchi, and R. Garnett, editors, Advances in Neural Information Processing Systems, volume 31, pages 7517-7527. Curran Associates, Inc., 2018
14. Ting Chen, Simon Kornblith, Kevin Swersky, Mohammad Norouzi, and Geoffrey Hinton. Big self-supervised models are strong semi-supervised learners, 2020
15. Xiao Liu, Fanjin Zhang, Zhenyu Hou, Zhaoyu Wang, Li Mian, Jing Zhang, and Jie Tang. Self-supervised learning: Generative or contrastive, 2020
16. Michael Gutmann and Aapo Hyvarinen. Noise-contrastive estimation: A new estimation principle for unnormalized statistical models. In Yee Whye Teh and Mike Titterington, editors, Proceedings of the Thirteenth International Conference on Artificial Intelligence and Statistics, volume 9 of Proceedings of Machine Learning Research, pages 297-304, Chia Laguna Resort, Sardinia, Italy, 13-15 May 2010. PMLR.
17. Zhirong Wu, Yuanjun Xiong, Stella Yu, and Dahua Lin. Unsupervised feature learning via non-parametric instance-level discrimination, 2018
18. Yonglong Tian, Dilip Krishnan, and Phillip Isola. Contrastive multiview coding, 2019
19. Kaiming He, Haoqi Fan, Yuxin Wu, Saining Xie, and Ross Girshick. Momentum contrast for unsupervised visual representation learning, 2019
20. Geoffrey Hinton, Oriol Vinyals, and Jeff Dean. Distilling the knowledge in a neural network, 2015
21. Ying Zhang, Tao Xiang, Timothy M. Hospedales, and Huchuan Lu. Deep mutual learning, 2017
22. Guo, Qiushan, et al. “Online knowledge distillation via collaborative learning.” Proceedings of the IEEE/CVF Conference on Computer Vision and Pattern Recognition. 2020.
23. Kaiming He, Xiangyu Zhang, Shaoqing Ren, and Jian Sun. Deep residual learning for image recognition, 2015
24. Zhirong Wu, Yuanjun Xiong, Stella Yu, and Dahua Lin. Unsupervised feature learning via non-parametric instance-level discrimination, 2018
25. Frederic Morin and Yoshua Bengio. Hierarchical probabilistic neural network language model. In AISTATS'05, pages 246-252, 2005.
26. Tomas Mikolov, Ilya Sutskever, Kai Chen, Greg S Corrado, and Jeff Dean. Distributed representations of words and phrases and their compositionality. In C. J. C. Burges, L. Bottou, M. Welling, Z. Ghahramani, and K. Q. Weinberger, editors, Advances in Neural Information Processing Systems, volume 26, pages 3111-3119. Curran Associates, Inc., 2013
27. Wang, Feng, et al. “Normface: L2 hypersphere embedding for face verification.” Proceedings of the 25th ACM international conference on Multimedia. 2017.
28. Jean-Bastien Grill, Florian Strub, Florent Altché, Corentin Tallec, Pierre H. Richemond, Elena Buchatskaya, Carl Doersch, Bernardo Avila Pires, Zhaohan Daniel Guo, Mohammad Gheshlaghi Azar, Bilal Piot, Koray Kavukcuoglu, Remi Munos, and Michal Valko. Bootstrap your own latent: A new approach to self-supervised learning, 2020
29. Kullback, Solomon, and Richard A. Leibler. “On information and sufficiency.” The annals of mathematical statistics 22.1 (1951): 79-86.

1. A deep learning-based method for unsupervised contrastive representation learning of a neural network, the method comprising the step of using a single-stage online knowledge distillation wherein at least a first model and a second model collaboratively learn from each other.

2. The method according to claim 1, wherein said method comprises the step of using the single-stage online knowledge distillation wherein the first and second models simultaneously learn from each other.

3. The method according to claim 1, wherein said method comprises the steps of:
selecting two untrained models for collaborative self-supervised learning;
passing a batch of input images through an augmentation module for generating randomly augmented views for each input image;
generating projections from each model, wherein the projections are associated with said randomly augmented views;
solving instance level discrimination task, such as contrastive self-supervised learning, for each model separately; and
aligning temperature scaled similarity scores across the projections of the models for knowledge distillation, preferably using Kullback—Leibler divergence.

4. The method according to claim 3, wherein the step of aligning temperature scaled similarity scores across the projections comprises the step of aligning a softmax probability of similarity scores of the first model with a softmax probability of similarity scores of the second model.

5. The method according to claim 1, wherein said method comprises the steps of optimizing a first model g_{θ1}(f_{θ1}(.)) by:
creating a pair of randomly augmented highly correlated views for each input sample in a batch of inputs;
creating a pair of representations by feeding the pair of highly correlated views into an encoder network f_{θ}(.);
feeding said pair of representations into a multi-layer perceptron g_{θ}(.); and
casting said method as an instance level discrimination task.

6. The method according to claim 1, wherein said method comprises the step of optimizing at least a second model g_{θ2}(f_{θ2}(.)) by:
creating a pair of randomly augmented highly correlated views for each input sample in a batch of inputs;
creating a pair of representations by feeding the pair of highly correlated views into an encoder network f_{θ}(.);
feeding said pair of representations into a multi-layer perceptron g_{θ}(.); and
casting said method as an instance level discrimination task

7. The method according to claim 6, wherein the step of casting the method as an instance level discrimination task comprises the step of teaching a network g_{θ}(f_{θ}(.)) to maximize similarities between positive embeddings pair <z′, z″> while simultaneously pushing away negative embeddings pairs <z′, kᵢ>, wherein i=(1, . . . , K) are the embeddings of augmented views of other samples in a batch and wherein K is the number of negative samples.

8. The method according to claim 7, wherein the step of maximizing similarities between positive embeddings pair <z′, z″> comprises the step of using noise contrast estimation.

9. The method according to claim 8, wherein the step of using noise contrast estimation comprises the step of using cosine similarity for computing a contrastive loss.

10. The method according to claim 1, wherein said method comprises the step of employing Kullback-Leibler divergence to distill knowledge across augmented views of the first model g_{θ1}(f_{θ1}(.)) and at least the second model g_{θ2}(f_{θ2}(.)) by aligning the softmax probabilities of the first model g_{θ1}(f_{θ1}(.)) and the second model g_{θ2}(f_{θ2}(.))

11. The method according to claim 1, wherein the method comprises the step of adjusting a magnitude of the knowledge distillation loss.
